(19) United States
(12) Patent Application Publication
(10) Pub. No.: US 2007/0164692 A1
(43) Pub. Date: Jul. 19, 2007

(54) Wireless systems and methods for controlling a telescope

(76) Inventors: Kenneth W. Baun, Trabuco Canyon, CA (US); Brian Tingey, Fountain Valley, CA (US); Ghassan El-Khatib, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/333,423

(22) Filed: Jan. 17, 2006

(51) Int. Cl. G05D 1/02

(52) U.S. Cl. 318/16

(57) ABSTRACT

Wireless control systems and methods for adjusting the position and/or alignment of a telescope. In one example, a wireless handheld controller enables a user to adjust a corresponding telescope from a remote location. The controller preferably communicates motion commands via radio frequency to a transceiver coupled to the telescope. The transceiver may also communicate status information to the controller regarding the current position and/or alignment of the telescope. In certain embodiments, the controller and transceiver are assigned corresponding identification codes and/or operational frequencies to enable handshaking between the controller and the transceiver during wireless communication.

### BACKGROUND OF THE INVENTION

1. Field of the Invention

The present disclosure relates to automated telescope systems and, more particularly, to wireless systems and methods for aligning and orienting such telescope systems.

2. Description of the Related Art

Recent advances in telescope technology have enabled the introduction of systems that provide for processor control systems capable of directing the positioning of a telescope. Such processor control systems often include interactive databases where users can determine a list of available astronomical objects for a given viewing time on a given day, can select from the list, and have the processor control system direct the telescope field of view to the selected object. Often, the interactive databases include various information on possibly thousands of astronomical objects. Moreover, such interactive systems often allow the user to actuate electronic controls to move the telescope on one or more axes at one or more drive speeds.

An example of an electronic control system for an automated telescope system is the Autostar Computer Controller commercially available from Meade Instruments Corp. (Irvine, Calif.). The Autostar Computer Controller includes an electronic handbox having a cord that connects to a control panel of the telescope system and that enables a user to adjust the telescope through controls on the handbox.

In many electronic control systems, some or all of the electronics communicate through wires to one or more control boxes or centers. In such systems, the wires often may limit the distance and/or position of a user during adjustment of the telescope. In addition, the corded handbox can be awkward and even obstructive at events, such as a star party, wherein multiple observers are using multiple telescopes in a single location, often without significant light.

### SUMMARY OF THE INVENTION

In view of the foregoing, conventional telescope systems do not provide a user with a way of conveniently controlling a telescope from a relatively close proximity. In particular, conventional telescope systems do not provide for the wireless control of the orientation and/or alignment of a telescope. Accordingly, certain embodiments of the invention include an automated telescope system having a wireless controller for adjusting and/or aligning a telescope. For example, the wireless controller may communicate via radio frequency (RF) communications to a transceiver coupled to a control panel of the automated telescope.

In certain embodiments, a user couples a wireless transceiver to an automated telescope system, such as, for example, through an interface panel. The user accesses a wireless controller, such as a handheld device, to issue motor motion commands to the transceiver. Based on these motor motion commands, the transceiver, in turn, outputs one or more control signals to at least one motor assembly to appropriately adjust the associated telescope.

To validate communication between the controller and the transceiver, the two devices may engage in a “handshake” routine prior to the communication of control information. For example, the controller and the receiver may be assigned corresponding identification codes or may operate on a particular frequency. Furthermore, if communication between the controller and the transceiver is interrupted or corrupted, such as by other RF transmissions, the controller may be configured to resend the subject data to the transceiver. Thus, the controller and receiver advantageously operate in proximity to other controllers and receivers. For example, a particular controller and receiver for a particular telescope system will be operable in close proximity to other controllers and receivers, such as, for example, during a star party where perhaps many telescopes are being operated in a small field or clearing.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a perspective view of an automated telescope system according to certain embodiments of the invention.

FIG. 2 illustrates a perspective view of an exemplary embodiment of a wireless controller usable with the automated telescope system illustrated in FIG. 1.

FIG. 3A illustrates a perspective view of an exemplary embodiment of a wireless transceiver device coupled to an interface panel of the automated telescope system illustrated in FIG. 1.

FIG. 3B illustrates a schematic diagram of an exemplary embodiment of the wireless transceiver device illustrated in FIG. 3A.

FIG. 4 illustrates a block diagram of an exemplary embodiment of a control system usable with the wireless controller illustrated in FIG. 2.

FIG. 5 illustrates a schematic diagram of an exemplary embodiment of main control circuitry usable with the control system illustrated in FIG. 4.

FIG. 6, which includes FIGS. 6A and 6B, illustrates a schematic diagram of an exemplary embodiment of communication circuitry usable with the control system illustrated in FIG. 4.

FIG. 7 illustrates a schematic diagram of an exemplary embodiment of interface circuitry usable with the control system illustrated in FIG. 4.

FIG. 8 illustrates a schematic diagram of an exemplary embodiment of user input circuitry usable with the control system illustrated in FIG. 4.

FIG. 9 illustrates a schematic diagram of an exemplary embodiment of illumination circuitry usable with the control system illustrated in FIG. 4.

FIG. 10 illustrates a schematic diagram of an exemplary embodiment of power circuitry usable with the control system illustrated in FIG. 4.

FIG. 11 illustrates a block diagram of an exemplary embodiment of a transceiver system usable with the automated telescope system illustrated in FIG. 1.

FIG. 12, which includes FIGS. 12A and 12B, illustrates a schematic diagram of an exemplary embodiment of transceiver circuitry of the transceiver system illustrated in FIG. 11.

### DETAILED DESCRIPTION OF THE PREFERRED EMBODIMENTS

Certain embodiments of the invention described herein include an automated telescope system having a wireless control system for controlling the positioning of a telescope with respect to the sky. For example, a user may access a wireless controller that communicates via radio frequency (RF) communications with a transceiver coupled to a control panel of the automated telescope.

In certain embodiments, a user couples a wireless transceiver to an automated telescope system, such as, for example, through an interface panel. The user accesses a wireless controller, such as a handheld device, to issue motor motion commands to the transceiver. Based on these motor motion commands, the transceiver, in turn, outputs one or more control signals to at least one motor assembly to appropriately adjust the associated telescope.

To validate communication between the controller and the transceiver, the two devices may engage in a “handshake” routine prior to the communication of control information. For example, the controller and the receiver may be assigned corresponding identification codes or may operate on a particular frequency. Furthermore, if communication between the controller and the transceiver is interrupted or corrupted, such as by other RF transmissions, the controller may be configured to resend the subject data to the transceiver.

An automated telescope having a wireless control system for operating the telescope will now be described with reference to the drawings summarized above. The drawings, associated descriptions, and specific implementation are provided to illustrate embodiments and do not limit the scope of the disclosure.

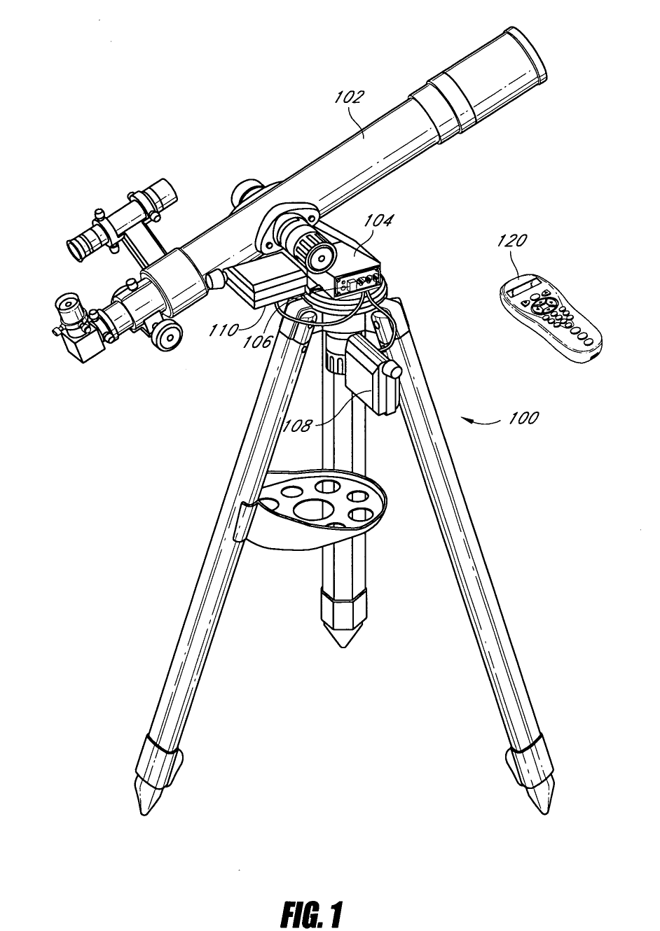

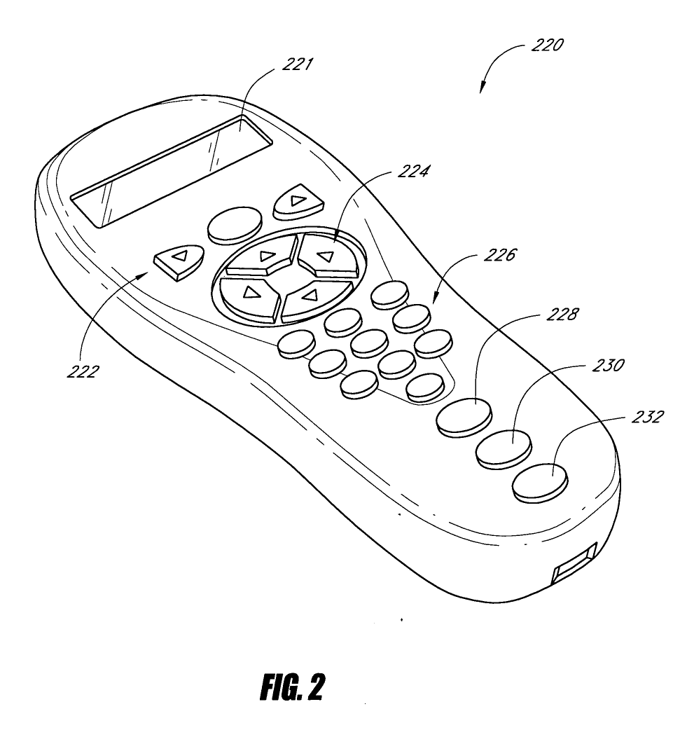

FIG. 1 illustrates an exemplary embodiment of an automated telescope system 100, such as, for example, for observing celestial and terrestrial objects. The telescope system 100 suitably comprises a telescope tube 102 that houses an optical system for resolving distant objects. In particular, the illustrated telescope tube 102 comprises a reflecting-type telescope, and more particularly, a Maksutov-Cassegrain telescope.

As shown, the telescope tube 102 is supported by a mount that facilitates movement of the telescope tube 102 about two orthogonal axes, a substantially vertical axis (e.g., an azimuth axis) and a substantially horizontal axis (e.g., an altitude axis). As those having skill in the art will appreciate, the horizontal and vertical axes of the mount, in combination, define a gimbaled support for the telescope tube 102, enabling the telescope tube 102 to pivot in a horizontal plane defined by the vertical (azimuth) axis and, independently, to pivot through a vertical plane defined by the horizontal (altitude) axis.

A skilled artisan will recognize from the disclosure herein a wide variety of alternative embodiments for the telescope system 102. For example, in other embodiments of the invention, the telescope's optical system utilize may other reflecting or refractor-type optical systems configured for telescopic use. For instance, the telescope system 100 may use one of the following types of optical systems: Newtonian, Schmidt-Newtonian, Schmidt-Cassegrain, Achromatic refractors, combinations of the same or the like.

As shown in FIG. 1, the automated telescope system 100 further comprises an electrical interface junction panel 104 that allows various electronic components to be interconnected and to support interoperability of the telescope system 100. As illustrated, the electrical interface junction panel 104 is coupled to a transceiver 106 for receiving wireless control signals for positioning the telescope tube 102

The illustrated telescope system 100 further includes motor portions for pivotally moving the telescope 102 about the azimuth axis and altitude axis. In particular, the motor portions include an azimuth axis motor assembly 108 and an altitude axis motor assembly 110. In certain embodiments, at least one of the motor assemblies 108 and 110 comprises a semi-intelligent, self-contained drive motor. For example, the motor assembly may include a DC brush-type motor, an associated electronics package hosted on a printed surface board, a drive and reduction gear assembly and/or an optical encoder assembly, configured together in a housing. Examples of such a motor assembly are described in more detail in U.S. Pat. No. 6,392,799, which is hereby incorporated herein by reference in its entirety.

The motor assemblies 108 and 110 are each affixed to the telescope mount and coupled to the azimuth and altitude axes, respectively, so as to be capable of pivotally moving the telescope tube 102 about the corresponding axis when the motor assembly is activated. Each of the motor assemblies may also be coupled to the respective corresponding receptacle in the electrical interface junction panel 104, which may function as a signal interface for the motor assemblies 108, 110 as well as for providing power and ground thereto.

The electrical interface junction panel 104 allows motor control signals to be directed to each of the motor assemblies 108 and 110. In certain embodiments, the motor control signals provide speed and/or direction information to the respective DC motor of each motor assembly. In certain embodiments, the electrical interface junction panel 104 further allows for signal communication between each respective one of the motor assemblies 108 and 110 and a wireless controller 120 through the transceiver 106.

As illustrated, the controller 120 advantageously comprises a wireless, handheld device. In certain embodiments, the controller 120 preferably communicates with the transceiver 106 via radio frequency (RF) communication. RF communication is preferred over infrared communication because infrared communication may interfere with the optical viewing properties of the automated telescope system 100. Furthermore, RF communication allows for non line-of-sight communication between the controller 120 and the transceiver 106. However, an artisan will recognize from the disclosure herein a variety of wireless communication protocols and frequencies capable of supporting wireless communication between the controller 120 and the transceiver 106. For instance, the controller 120 and the transceiver 106 may communicate via Wi-Fi and/or Bluetooth transmissions.

In certain embodiments, the controller 120 comprises a self-contained, computer control device enclosed within a functional housing. The controller 120 may operate as a dual-axis motor drive corrector that enables telescope axis motor motion, from small tracking corrections involved with long exposure astrophotography at sidereal rates, to fast slewing movements performed during new object acquisition. The controller 120 may also support motor movement commands from microslewing a telescope to, and for precision centering of a telescope onto, selected celestial objects.

In addition, in certain embodiments, the controller 120 is able to command certain special movement functions, such as, for example, selecting various drive rates for the telescope motors, adjusting an optional electronic focuser, and the like. Furthermore, the controller 120 may perform a variety of object acquisition and tracking functions that permit an automated telescope system to automatically find and/or track desired celestial objects.

In certain embodiments, when using the automated telescope system 100, a user couples the transceiver 106 to an appropriate receptacle of the electrical interface junction panel 104 and further couples the motor assemblies 108 and 110 into the respective receptacles. The user is then able to communicate motion commands to the automated telescope system 100 by accessing appropriate controls on the handheld controller 120. In certain embodiments, signals corresponding to the desired motion are directed by the transceiver 106 to the appropriate motor assembly through the electrical interface junction panel 104.

For example, if a user desires to slew the telescope 102 in a counter-clockwise direction, he or she may enter a command into the controller 120 instructing the telescope system 100 to move the telescope 102 “left.” In response to receiving the “left” command from the controller 120, the transceiver 106 commands the azimuth axis motor assembly 108 to activate its integral motor to rotate the telescope 120 in the specified direction. In a like manner, when a user desires to elevate the telescope 102 in an upwardly direction, the user may enter the appropriate “up” command into the controller 120, thus activating the altitude motor assembly 110 to pivot the telescope 102 upwardly about the altitude axis.

With reference to the automated telescope system 100 of FIG. 1, a skilled artisan will understand from the disclosure herein that the illustrated telescope system 100 may comprise an integrated telescope such that the altitude motor assembly 110 and the azimuth motor assembly 108 are disposed within a vertically positioned fork arm and the telescope mount base, respectively. In other embodiments, one or more of the motor assemblies 108 and 110 may not connect to the electrical interface junction panel 104. For example, the telescope system 100 may comprise motor wiring internal to the structure of the telescope mount.

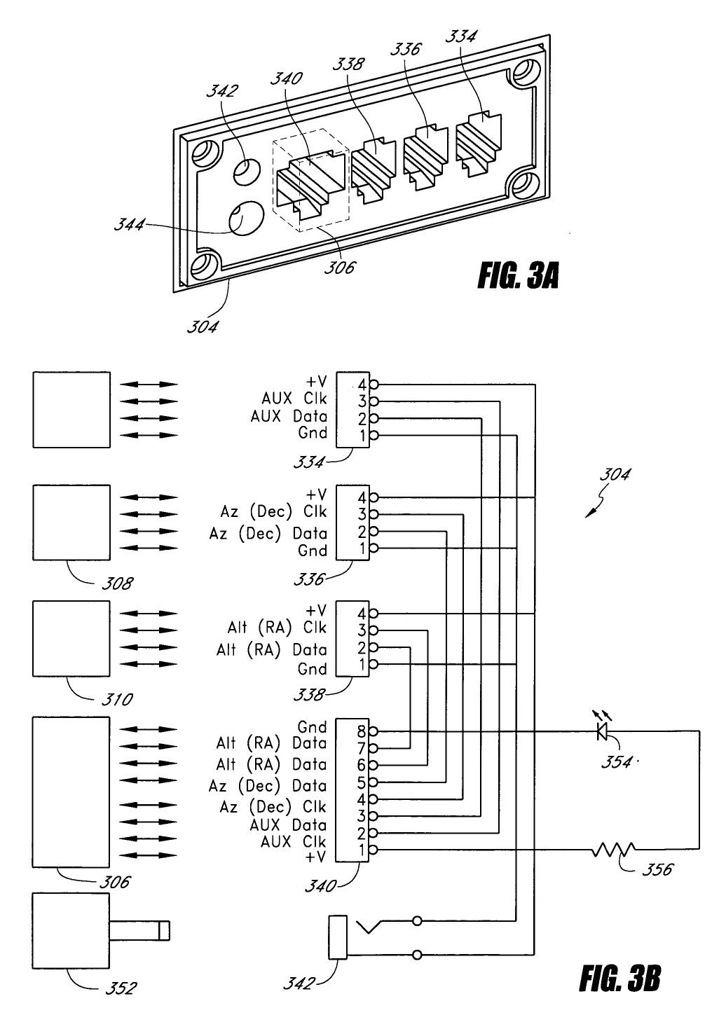

FIG. 2 illustrates a perspective view of an exemplary embodiment of a wireless controller 220 suitable for use in combination with the automated telescope system 100 of FIG. 1. In particular, FIG. 2 depicts an exterior portion of the controller 220 as having various function keys to be used by a user in commanding a telescope to engage in various evolutions. In certain embodiments, the intelligent controller 220 comprises an ergonomic handheld package that functions as a full-spectrum control device capable of intelligently defining and commanding motor movements required for astronomical observations, as well as for implementing their pre- and post-processing features in a manner similar to a microcomputer.

The illustrated controller 220 suitably comprises a display 221 capable of displaying text, numeric and/or graphic output data in a form that may be consulted by a user in operating the telescope system. For example, prompts, user queries, confirmation messages, combinations of the same and the like may be provided on the display 221. As shown in FIG. 2, the display 221 comprises an LCD display screen. For example, the display 221 may comprise a two-line, sixteen character scrolling screen display. In other embodiments, the display 221 may comprise a light emitting diode (LED) display or other like means for showing data.

As shown, the controller 220 further includes a plurality of scroll keys 222 for controlling the display of information. For example, the scroll keys 222 may allow a user to scroll through a database listing or through available menu options shown on the display 221.

The illustrated controller 220 further comprises telescope motion direction keys 224, labeled with directional arrows indicating up, down, right and left, that provide the inputs for enabling the telescope system to move or microslew in the specified direction at any one of a number of allowable speeds. For example, the number of allowable speeds may be limited by a number of speed bits within a speed and direction command. In certain embodiments, the number of allowable speeds for a semi-intelligent motor is eight, with one of the eight allowable speeds being reserved for the motor stop command. Once the desired speed is selected, the user depresses one of the desired motion direction keys 224 to command the corresponding semi-intelligent motor to move the telescope system at the specified speed in the desired direction.

Furthermore, the illustrated controller 220 comprises an alphanumeric keypad 226 that allows a user to enter particular values. The controller 220 also includes several function keys. For example, an “ENTER” key 228 allows a user to select a file menu option or function and/or to define the completion of an entry made in response to a system prompt. A “MODE” key 230 allows the user to exit the current menu in order to return to a previous menu, and a “GOTO” key 232 commands the telescope system to slew the telescope to an object chosen from, for example, an internal celestial database listing.

In certain embodiments, the exterior portion of the controller 220 features an ergonomic design for handheld comfort. Furthermore, the controller 220 may provide red LED back-illumination for one or more keys and/or for the display 221.

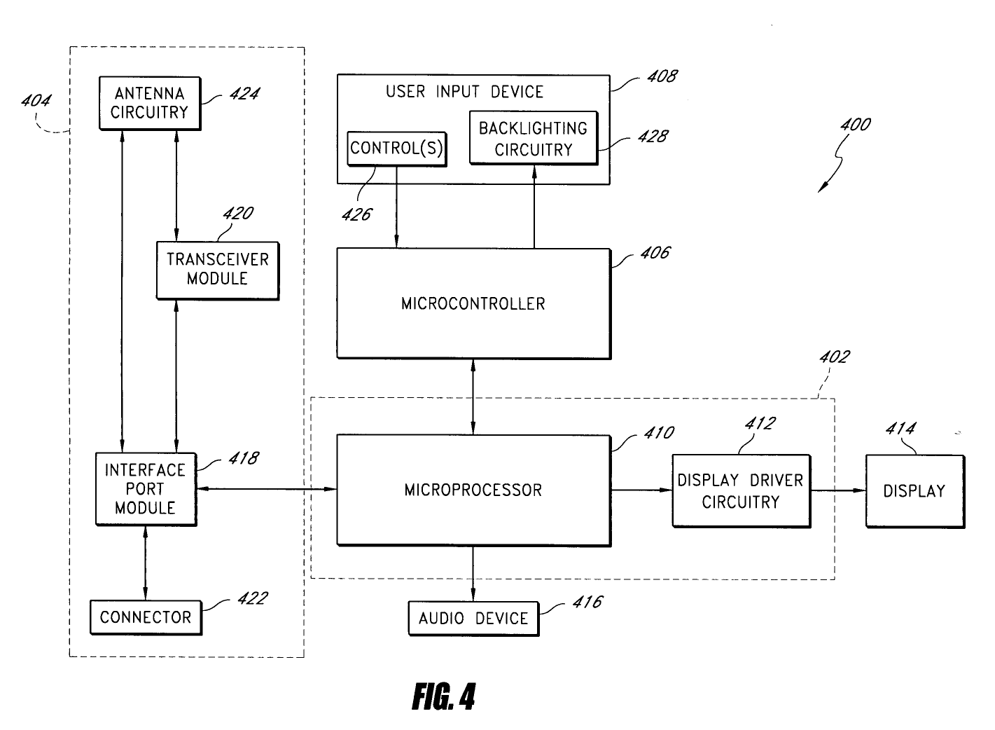

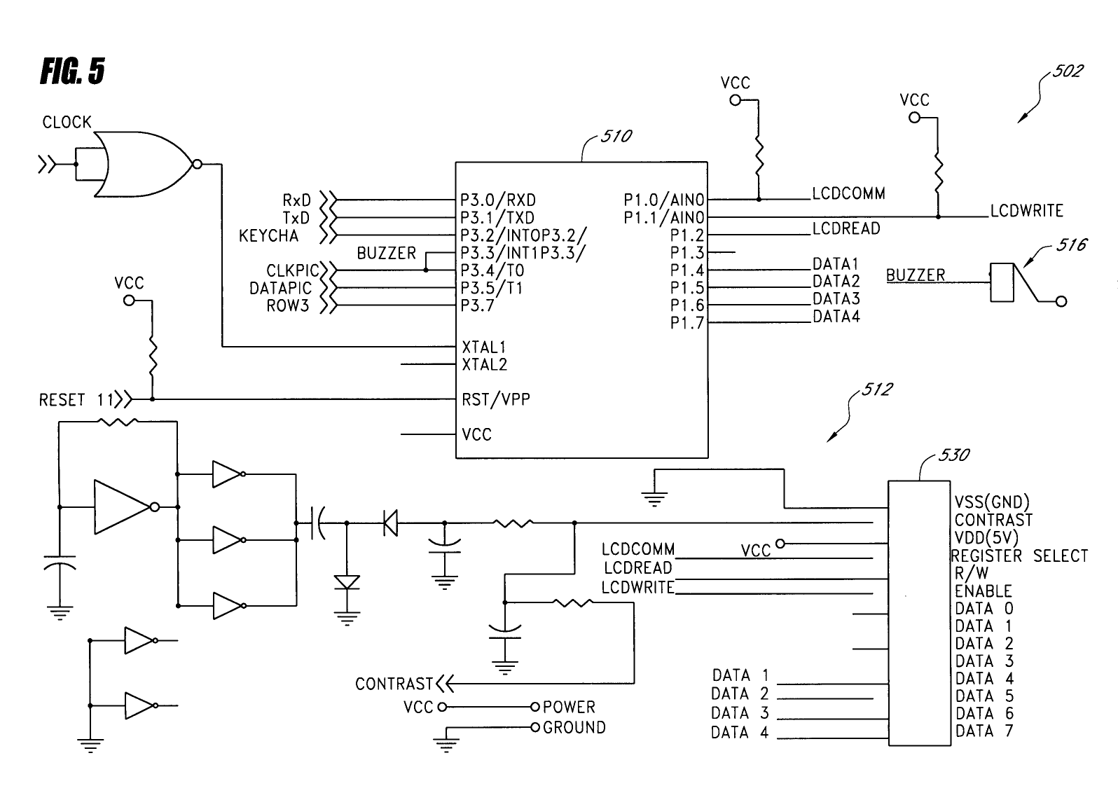

FIGS. 3A and 3B illustrate exemplary embodiments of mechanical and electrical configurations of an electrical interface junction panel 304 suitable for use with the automated telescope system 100 of FIG. 1. As shown in FIG. 3A, the interface junction panel 304 suitably comprises four RJ11-type connector receptacles with three of the receptacles 334, 336 and 338 comprising 4-pin RJ11 connectors and one of the receptacles 340 comprising an 8-pin RJ11 connector. In addition to the RJ11 correctors, the electrical interface junction panel 304 includes a “mini-pin” type 12-volt power receptacle 342 and a visible “power present” indicator comprising an LED 344 mounted to shine through a recessed opening in the panel 304.

FIG. 3B illustrates exemplary electrical connections made between and among the 4-pin RJ11 connectors 334, 336, and 338, the 8-pin RJ11 connector 340 and the 12-volt power pin 342. In certain embodiments, external power is supplied to the various connectors of the electrical interface panel 304 by a suitable 12-volt power source 352, such as for example, a dedicated 12-volt battery pack or, alternatively, an adapter configured to mate with a 12-volt automotive battery. In certain embodiments, the external power source 352 is plugged into the 12-volt power pin 344, which distributes power to pin 1 of the 8-pin RJ11 connector 340 and a number 4 pin of each the 4-pin RJ11 connectors 334, 336 and 338.

In addition to power and ground, each of the 4-pin RJ11 connectors 334, 336 and 338 further comprises a 2-conductor serial signal path with pin number 3 to a serial signal termed “CLK” and a signal path with pin number 2 to a serial signal termed “DATA.” In certain embodiments, the first 4-pin RJ11 connector 334 is configured as a connector for supporting various pieces of auxiliary equipment, and its serial signal lines are correspondingly each identified as “AUX.” The CLK and DATA signals associated with pins 3 and 2 respectively are identified as AUX CLK and AUX DATA respectively.

Likewise, the next 4-pin RJ11 connector 336 is configured to provide serial CLK and DATA signals to an altitude motor assembly 310, such as are similar to the altitude motor assembly 110 illustrated in FIG. 1 (or, alternatively, to a declination motor assembly). The CLK and DATA signal lines of the connector 336 are thus denoted ALT CLK (dec CLK) and ALT DATA (dec DATA), respectively. The next 4-pin RJ11 connector 338 is configured to provide serial CLK and DATA to an azimuth motor assembly 308, such as one similar to the azimuth motor assembly 108 depicted in FIG. 1 (or, alternatively, to a right ascension motor assembly). The CLK and DATA signals of connector 338 are denoted accordingly.

The 8-pin connector 340 of the interface junction panel 304 is preferably configured to couple to a transceiver 306, such as are similar to the transceiver 106 of FIG. 1. In other embodiments, the connector 340 may comprise a different form or layout, such as a 4-pin connector, for coupling to the transceiver 306.

The interface junction panel 304 described in connection with the exemplary embodiments of FIGS. 3A and 3B is devised to be suitable for use in connection with the automated telescope system of FIG. 1. Since the telescope system 100 does not require external connections to be made to its motor systems in certain embodiments, the interface junction panel 304 need not include the 4-pin RJ11 connectors which couple to the motor assemblies 108 and 110. Thus, the interface junction panel 304 may include an 8-pin RJ11 connector for coupling to the transceiver 306 and one or more 4-pin RJ11 connectors for coupling to a plurality of auxiliary components through one or more “AUX” ports.

It will be understood that the electrical interface junction panel 304 provides a means for routing power and control signals between and among an external power source, a control device and various optional auxiliary pieces of equipment, such as electronic focusers, electronic leveling devices, a global positioning system receiver, and the like.

In certain embodiments of the invention, the telescope systems described herein are fully automated with distributed intelligence in that high-level user commands entered into a controller are translated into appropriate control signals suitable for action by the motors. Each motor is itself intelligent in that each motor is associated with a motor controller circuit that receives command and control signals, such as from a transceiver, and manipulates motor motion in response. Each of the motors may be, in turn, coupled to a motion feedback evaluation device, such as an optical encoder assembly, so that actual travel about each respective telescope axis is evaluated against commanded travel.

In certain embodiments of the invention, the primary control of an automated telescope system with distributed intelligence is provided by a fully intelligent telescope system controller. For example, functions of an automated telescope system may be implemented through an input portion of a wireless controller, such as the controller 220 depicted in FIG. 2. In certain embodiments, the wireless controller receives user I/O information and performs any needed data processing under application software program control. Such data processing typically results in some form of desired telescope motion with the controller and/or telescope system being able to calculate the direction and extent of the required motor motion and being further able to direct the appropriate motor assembly to make the desired adjustments.

For instance, a user may interface with a keypad portion of the controller by depressing the various alpha numeric and/or function keys provided thereon. Furthermore, in certain embodiments, once the automated telescope system has been appropriately aligned, an object database may be accessed to automatically slew the telescope system to a particular celestial (or terrestrial) object an observer desires to view or photograph.

As will be understood from the disclosure herein, one or more of the components of the telescope system 100 may comprise its own operational intelligence and may utilize a serial or other command interface to a controlling entity to perform its designated functions. In such embodiments, because each component comprises sufficient intelligence (processing power) to execute its tasks without higher level supervision, the controlling entity is free to execute application programs, perform complex arithmetic calculations, maintain database entries, and the like.

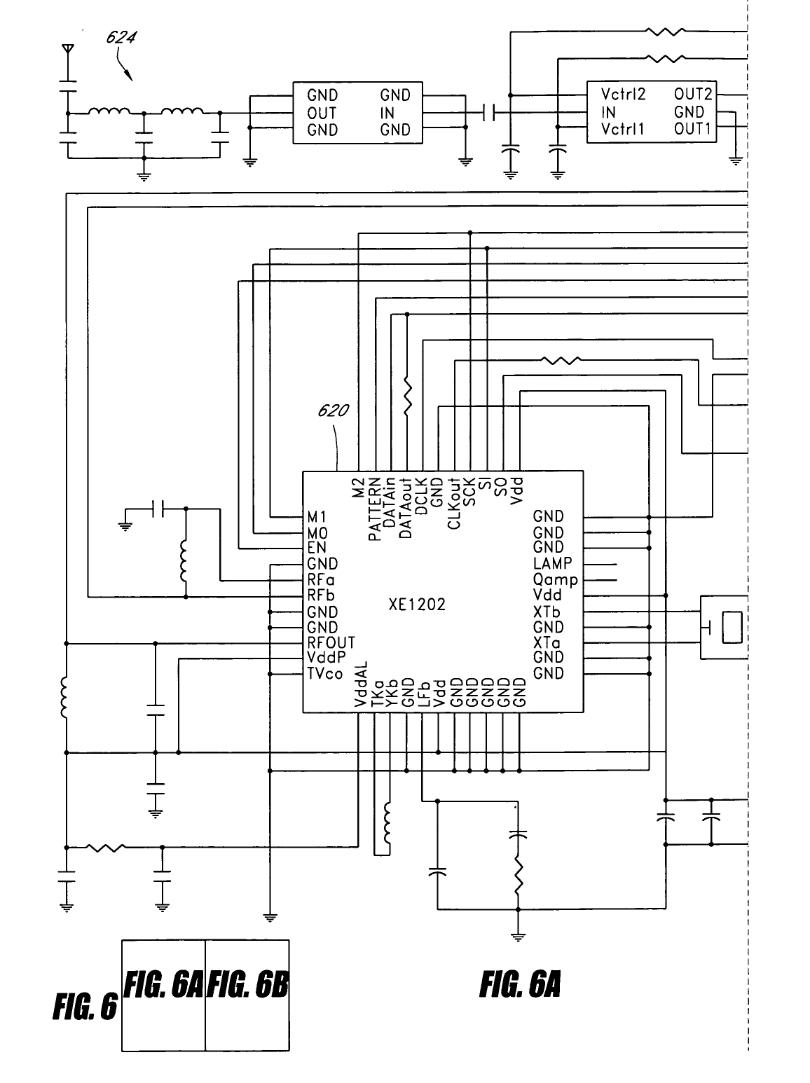

FIG. 4 illustrates a block diagram of an exemplary embodiment of a control system 400 usable with the wireless controller 220 illustrated in FIG. 2. For exemplary purposes, the control system 400 will be described hereinafter with reference to the components of the automated telescope system 100 illustrated in FIG. 1.

In certain embodiments, the control system 400 functions as a semi-intelligent drive motor motion control system. In particular, the control system 400 processes data to generate appropriate motion commands that are transmitted to the transceiver 106 of the telescope system 100. The transceiver 106 and/or the motor assemblies 108, 110 then suitably process the received motion commands into control signals suitable for operating the motors. In such embodiments, the control system 400 of the wireless controller 120 is capable of inducing a variety of telescope orientation and object tracking functions in a straightforward and inexpensive manner.

As illustrated, the control system 400 comprises main control circuitry 402 coupled to communication circuitry 404 and a microcontroller 406. The control circuitry 402 interfaces with the communication circuitry 404 to receive data from and/or to transmit data to a remote device, such as for example, the transceiver 106. For example, the control circuitry 402 may process input signals received from the microcontroller 406 to generate command and/or control signals to be wirelessly transmitted via the communication circuitry 404 to the transceiver 106. These command signals may then be used to appropriately adjust and/or align the telescope 102.

As illustrated in FIG. 4, the main control circuitry 402 further comprises a microprocessor 410. In certain embodiments, the microprocessor 410 is responsible for implementing the top-level firmware architecture of the control system 400 and for executing suitable application software routines pertinent to the exemplary intelligent telescope system. For example, the microprocessor 410 may perform high-level application execution tasks, associated data handling and numerical processing in order to define the appropriate motion commands for controlling motor assemblies 108, 110 of the automated telescope system 100. In certain embodiments, the microprocessor 410 advantageously comprises a general purpose processor. In other embodiments, the microprocessor 410 may comprise an application specific processor.

The microprocessor 410 further couples to display driver circuitry 412 to communicate with a display 414 that provides information to a user. For example, the display 414 may comprise an LCD display such as the display 221 illustrated in FIG. 2. The control circuitry 402 also communicates with an audio device 416 that is capable of providing an audible signal to a user.

The illustrated communication circuitry 404 further comprises an interface port module 418 that communicates with the microprocessor 410, a transceiver module 420, a connector 422 and antenna circuitry 424. In certain embodiments, the interface port module 418 comprises a universal asynchronous receiver-transmitter (UART) device capable of handling asynchronous serial communication.

For example, in certain embodiments, the interface port module 418 advantageously comprises RS-232 interface port circuitry, and the connector 422 comprises an RS-232 interface connector. In such embodiments, the interface port module 418 may support bi-directional communication between the microprocessor 410 and an external information source such as a personal computer (PC), a cellular phone, portable computing device (e.g., laptop, personal digital assistant (PDA)), a network interface link (e.g., an internet link), an attached or portable disk or disk drive, combinations of the same and the like. For instance, in certain embodiments, the connector 422 may comprise a universal serial bus (USB) or an IEEE 1394 port.

The interface port module 418 may also be configured to communicate with a similar RS-232 port of an intelligent controller associated with another separate telescope system. It will be understood that, when operating under appropriate I/O control, the microprocessor 410 in connection with the interface port module 418 provides means for quickly and easily interfacing the control system 400 to an external source of program code, data or other information that a user might desire to incorporate into the instructions or data tables of the intelligent controller 220 of the present invention.

It will also be understood that the connector 422 provides for the updating and/or maintaining of system intelligence by allowing “new object” loadability. For example, system software, updated celestial object catalog tables, combinations of the same and the like, may be loaded into the control system 400 through the connector 422.

In certain embodiments, the transceiver module 420 of the communication circuitry 404 advantageously comprises a low power, integrated UHF transceiver that processes and communicates information between the interface port module 418 and the antenna circuitry 424.

The antenna circuitry 424 is advantageously configured to transmit and/or receive information from the transceiver 106 of an associated telescope 102. In certain embodiments, the antenna circuitry 424 is formed by a trace on a printed circuit board and is capable of RF transmission and/or reception. In yet other embodiments, the antenna circuitry 424 may be configured for Wi-Fi and/or Bluetooth communication.

As illustrated in FIG. 4, the microprocessor 410 is further coupled to the microcontroller 406, such as through a control bus. The microcontroller 406 is, in turn, coupled to a user input device 408, which further includes one or more controls 426 and backlighting circuitry 428. In such a configuration, the microcontroller 406 functions as an input/output device that translates user input received through the controls 426 and provides signals, derived from the user input, to the microprocessor 410. Furthermore, the microcontroller 406 controls the function of backlighting circuitry 428, such as to illuminate one or more of the controls 426.

In certain embodiments, the microcontroller 406 comprises a purpose configured microprocessor or microcontroller that is capable of executing applications and/or command sets suitable for, for example, developing a digital clock, controlling a keypad, performing arithmetic calculations, combinations of the same and the like. Furthermore, the microcontroller 406 may be capable of generating command and control signals suitable for use by a semi-intelligent motor and/or an auxiliary device, such as an electronic focusing system or GPS receiver operating in accordance with the NMEA interface standard. In such embodiments, the microcontroller 406 may provide such command and control signals to the microprocessor 410 for communication to the transceiver 106 through the communication circuitry 404.

The illustrated user input device 408 is capable of receiving commands from a user relating to the position and/or adjustment of the telescope 102. For instance, the one or more controls 426 of the user input device 408 may include a plurality of buttons or keys, such as for example, a keypad. The user input device 408 also advantageously includes backlighting circuitry 428 that facilitates viewing of the controls 426 in dark conditions.

As described, the control system 400 of the wireless controller 120 advantageously communicates via radio frequency with the transceiver 106 associated with the telescope 102. In certain embodiments, the control system 400 first performs a “handshaking” routine to establish and/or validate a connection between the control system 400 and the transceiver 106. A skilled artisan will recognize from the disclosure herein a wide variety of handshaking routines or procedures that may be used with the automated telescope system 100 to relatively quickly establish a wireless connection between the control system 400 and the transceiver 106. Such a handshaking routine advantageously prevents interference from other automated telescope systems or from other nearby RF communication.

For example, in certain embodiments, both the transceiver 106 and the control system 400 are assigned corresponding identification codes for use during the handshaking routine to validate communication. In certain embodiments, the identification code comprises a 16-bit binary code, which provides for over 65,000 unique combinations. In other embodiments, other lengths or types of identification codes and/or data encryption may be used.

In certain embodiments, the transceiver 106 and control system 400 are designed to operate on one of multiple available frequencies. Such a choice of frequency may be used in place of, or in combination with a unique identification code to establish a connection between the transceiver 106 and the control system 400.

Once a connection is established between the transceiver 106 and the control system 400, the communication therebetween, in certain embodiments, preferably comprises small bursts or packets. Such quick transmissions may occur, for example, when the user inputs information into the user input device 408 and/or when the control system 400 receives information (e.g., current alignment and/or position) relating to the telescope 102. In certain embodiments, if a collision occurs during data transmissions of the telescope system 100, the control system 400 and or transceiver 106 preferably resends the information after a predetermined period of time.

As will be noted, the illustrated intelligent control system 400 suitably comprises a dual processor system (i.e., the microcontroller 406 and microprocessor 410). As described, the two processors may include a general purpose processor and a purpose configured processor that bifurcate the control system's processing and control functions into a first sub-system comprising the microprocessor 410 and a second subsystem comprising the microcontroller 406 for implementing I/O control. In other embodiments of the invention, the control system 400 may operate with a single general purpose or purpose configured processor. In yet other embodiments, the control system 400 may include more than two processors.

Furthermore, a skilled artisan will recognize from the disclosure herein that at least one of the components of the control system 400 may comprise one or more modules configured to execute on one or more processors. The modules may comprise, but are not limited to, any of the following: hardware or software components such as software object-oriented software components, class components and task components, processes, methods, functions, attributes, procedures, subroutines, segments of program code, drivers, firmware, microcode, applications, algorithms, techniques, programs, circuitry, data, databases, data structures, tables, arrays, variables, combinations of the same or the like.

A skilled artisan will also recognize from the disclosure herein a wide variety of alternative configurations for the control system 400. For example, in certain embodiments, the microprocessor 410 may be further coupled to a real-time clock so as to be capable of performing time calculations appropriate to celestial motion. For example, such a real-time clock may be preferably implemented as a precision timing reference clock signal generator, such as a UTC clock that is used to calculate sidereal time intervals and that preferably resides as an integral component of the control device 400. Alternatively, the real-time clock may be implemented as a separate off-board integrated circuit comprising a UTC clock that communicates with the control system 400 over the connector 422.

It should also be understood that a GPS receiver is able to provide timing signals that can function as precision timing reference signals in a manner similar to a UTC clock. Coupling a GPS receiver to the control system 400 enables the control system 400 to receive not only coordinated timing data but also user position data from a single external apparatus coupled to the control system 400.

In yet other embodiments, the control system 400 may further include memory such as a programmable non-volatile read-only memory (ROM) circuit (e.g., a FLASH programmable ROM (FRPOM), a electrically erasable programmable read-only memory (EEPROM), or the like) that hosts an instruction set for downloaded applications and software routines, data tables such as a stellar object position database, the Messier object catalog list, an earth-based latitude/longitude correspondence table, combinations of the same or the like. In yet other embodiments, the memory may be implemented as an external storage unit such as a hard drive, a programmable CD/ROM, or the like.

Although the control system 400 has been described with reference to the handheld controller 120, a skilled artisan will recognize a wide variety of devices and/or systems that may implement at a least a portion of the control system 400. For example, at least a portion of the control system 400 may reside on a portable computing device, such as a laptop, a PDA, or a cellular phone. The portable computing device may communicate directly with the transceiver 106, or may alternatively communicate with the controller 120, such as through a wired or wireless connection, to communicate with the transceiver 106.

For example, in certain embodiments, a user may access a laptop that communicates with the wireless controller 120 via a Wi-Fi connection or a Bluetooth connection. For instance, the laptop, or other like computing device, may include a Bluetooth transmitter for communicating with the controller 120 or directly with the transceiver 106. In such embodiments, the user may use the laptop to align the telescope 102 and/or to download images captured by the telescope 102.

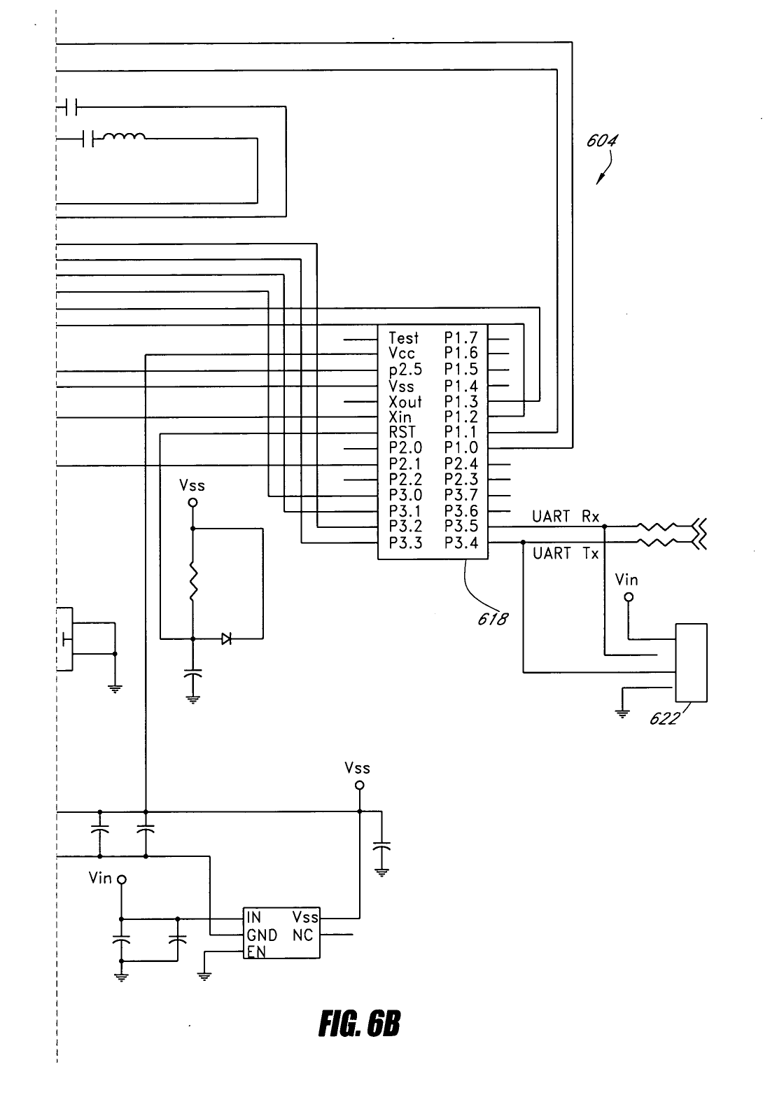

For exemplary purposes, FIGS. 5-10 illustrate detailed schematics of components and circuitry usable to form the control system 400 of FIG. 4.

FIG. 5 illustrates a detailed schematic of an exemplary embodiment of control circuitry 502 usable with the control system 400 depicted in FIG. 4. In certain embodiments, the control circuitry 502 performs the same or similar functions as described with reference to the control circuitry 402 of FIG. 4.

As shown, the control circuitry 502 comprises a microprocessor 510. In certain embodiments, the microprocessor 510 comprises the low voltage, CMOS 8-bit AT89C401 microcontroller manufactured by Atmel Corporation (San Jose, Calif.).

The control circuitry 502 further comprises display driver circuitry 512 that receives data from the microprocessor 510. In particular, the illustrated display driver circuitry 512 includes a display interface 530 that receives data to be displayed, and control signals related thereto, from the microprocessor 510. In certain embodiments, the display interface 530 comprises an LCD interface that couples to the display 414.

The microprocessor 510 further communicates with a buzzer 516. In certain embodiments, the buzzer 516 provides audio signals to the user in response to certain events and/or commands.

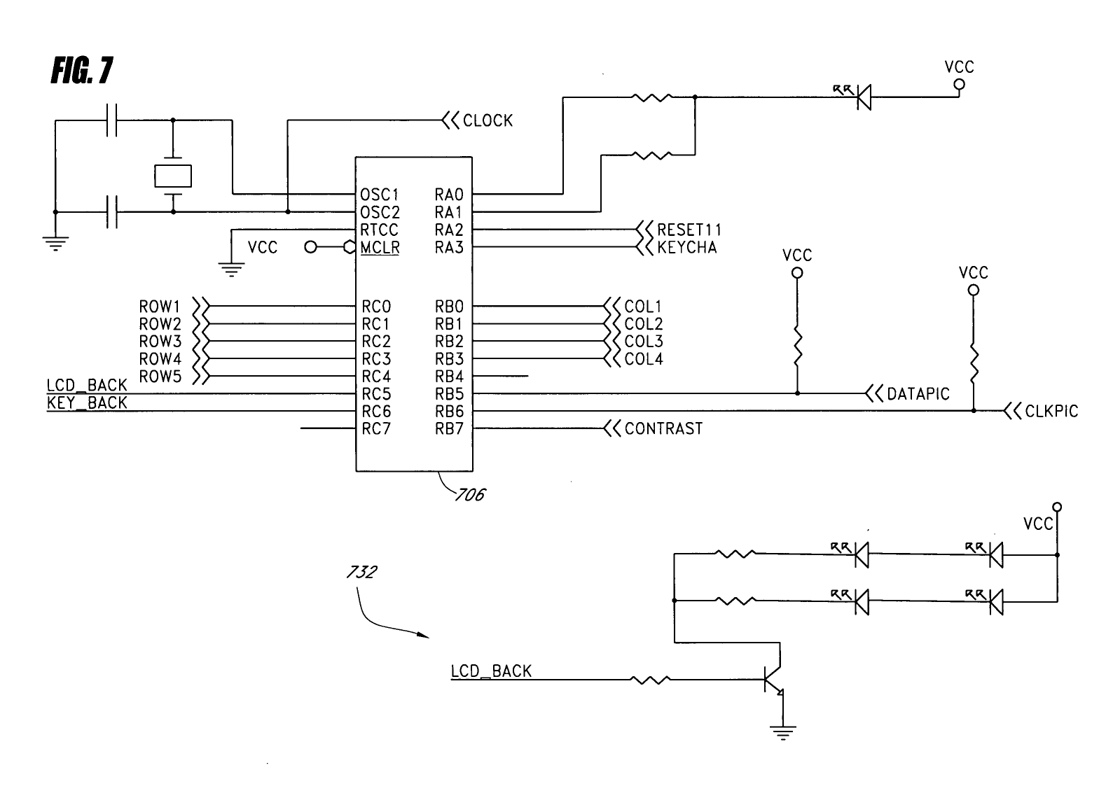

FIG. 6 illustrates a detailed schematic of an exemplary embodiment of communication circuitry 604 usable with the control system 400 depicted in FIG. 4. In certain embodiments, the communication circuitry 604 performs the same or similar functions as described with reference to the communication circuitry 404 of FIG. 4.

As shown, the communication circuitry 604 includes an interface port module 618 that communicates with a transceiver module 620, a connector 622 and antenna circuitry 624. In certain embodiments, the interface port module 618 is a UART device capable of handling asynchronous serial communication, such as received from the antenna circuitry 624 or from the connector 622.

In certain embodiments, the connector 622 comprises an RS-232 interface connector, as described in more detail previously. The connector 622 advantageously provides for a means for receiving information from a wide variety of data storage or transmission devices.

The transceiver module 620 preferably comprises a low power, integrated UHF transceiver. In certain embodiments, the transceiver module 620 comprises an XE1202 direct conversion, half-duplex data transceiver manufactured by Xemics.

In certain embodiments, the antenna circuitry 624 is advantageously configured to engage in RF communication with an external device, such as the transceiver 106 of FIG. 1.

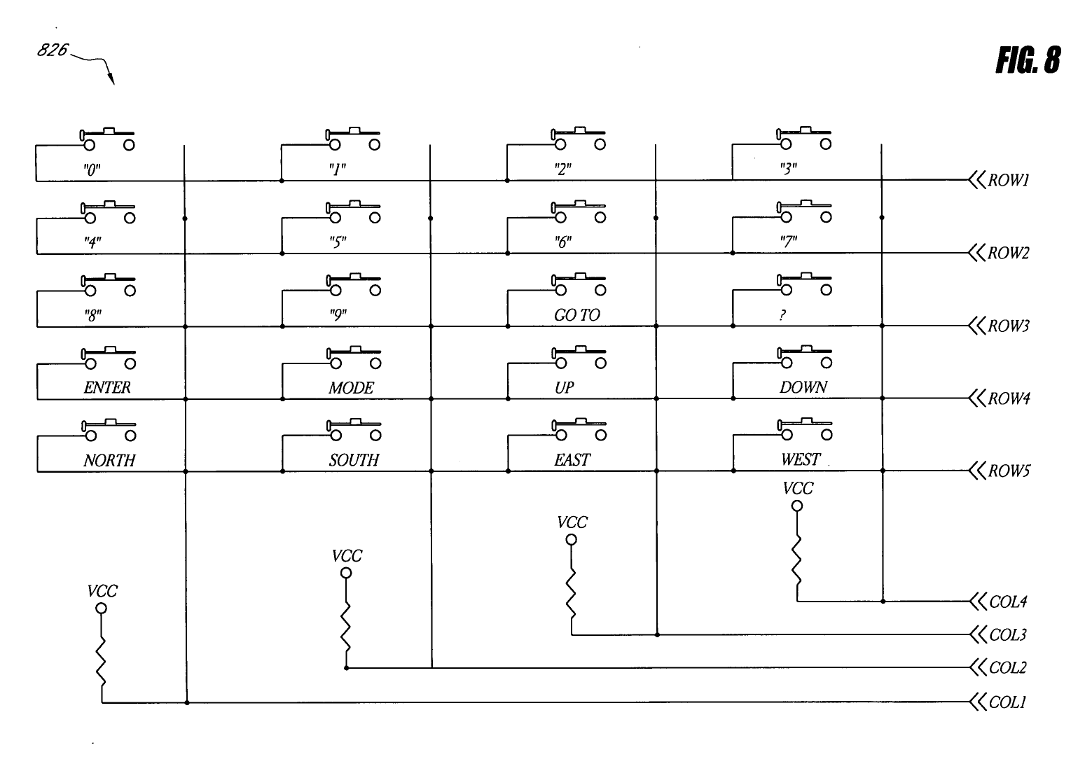

FIG. 7 illustrates a detailed schematic of an exemplary embodiment of a microcontroller 706 and associated circuitry usable with the control system 400 depicted in FIG. 4. As shown, the microcontroller 706 comprises an EPROM/ROM based, 8-bit PIC16C57 microcontroller manufactured by Microchip Technology, Inc.

The illustrated microcontroller 706 receives inputs from multiple keys, as illustrated by lines ROW1-ROW5 and COL1-COL4. The microcontroller 706 further communicates with backlighting circuitry 732 to illuminate a display and/or one or more input keys.

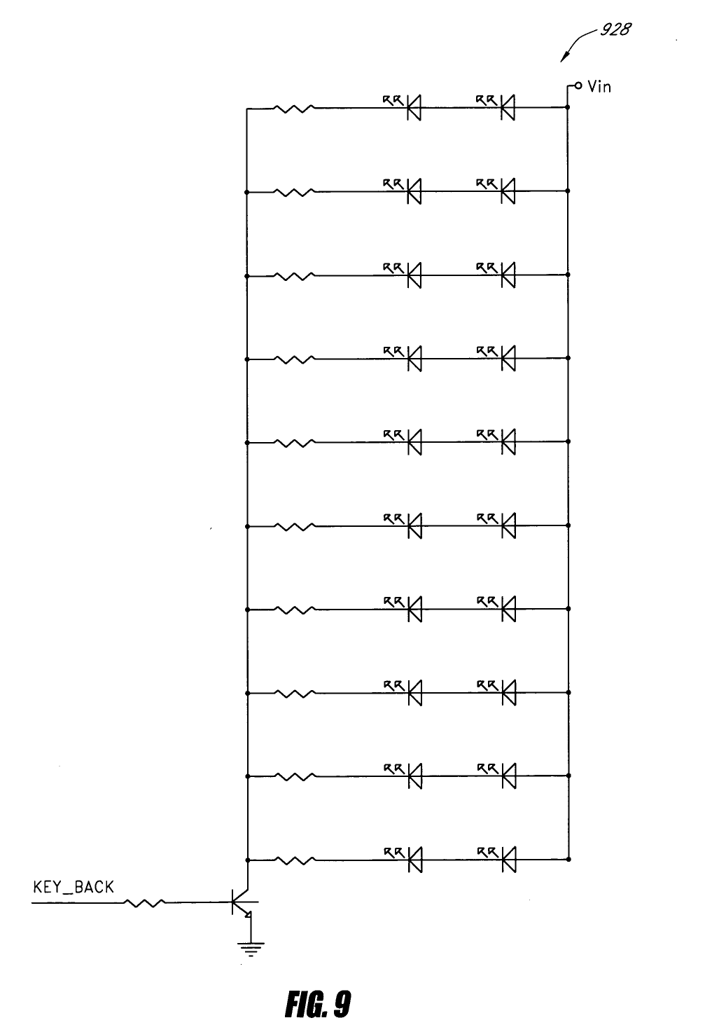

FIG. 8 illustrates a detailed schematic of an exemplary embodiment of user input circuitry 826 usable with the control system 400 depicted in FIG. 4. In particular, the user input circuitry 826 comprises a plurality of switches, arranged in rows and columns, which are preferably used to communicate data to a microcontroller, such as the microcontroller 706 of FIG. 7. In certain embodiments, each of the switches corresponds to a physical key depicted on the controller 220 of FIG. 2. When the user activates one of the illustrated switches, the user input circuitry 826 causes a corresponding signal to be output to the microcontroller.

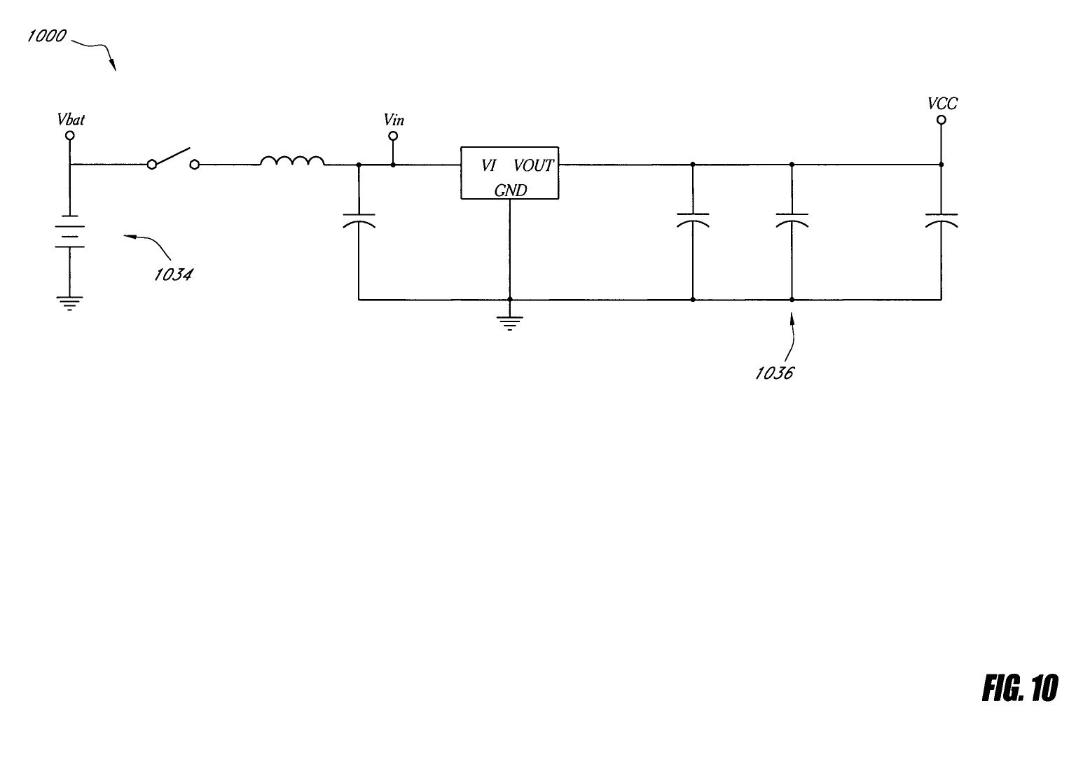

FIG. 9 illustrates a detailed schematic of an exemplary embodiment of backlighting circuitry 928 usable with the control system 400 depicted in FIG. 4. In particular, the backlighting circuitry 928 comprises a plurality of LEDs, wherein pairs of LEDs are connected in series with a resistor, the combination of which is coupled to a voltage source. In certain embodiments, each LED is associated with one or more user input controls, such as the physical keys depicted on the controller 220 of FIG. 2. As further illustrated, when a KEY_BACK line of the backlighting circuitry 928 is high, such as when activated by the microcontroller 706, the LEDs turn on to illuminate the user input controls.

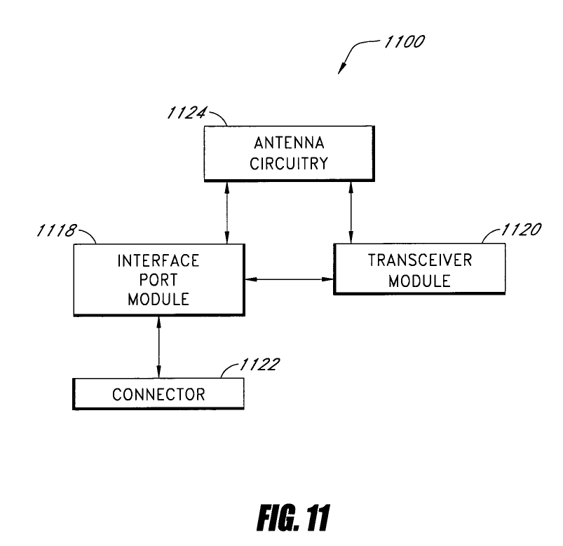

FIG. 10 illustrates a detailed schematic of an exemplary embodiment of power circuitry 1000 usable with the control system 400 depicted in FIG. 4. As shown, the power circuitry 1000 comprises a power source 1034. In certain embodiments, the power source 1034 advantageously comprises a portable power source, such as a plurality of standard AA alkaline batteries, to enable free movement of the associated controller. The illustrated power source 1034 is further coupled through a switch to a voltage regulating circuit 1036, which includes a plurality of capacitors that function to decouple the integrated circuit components of the associated control system 400 from the power source 1034.

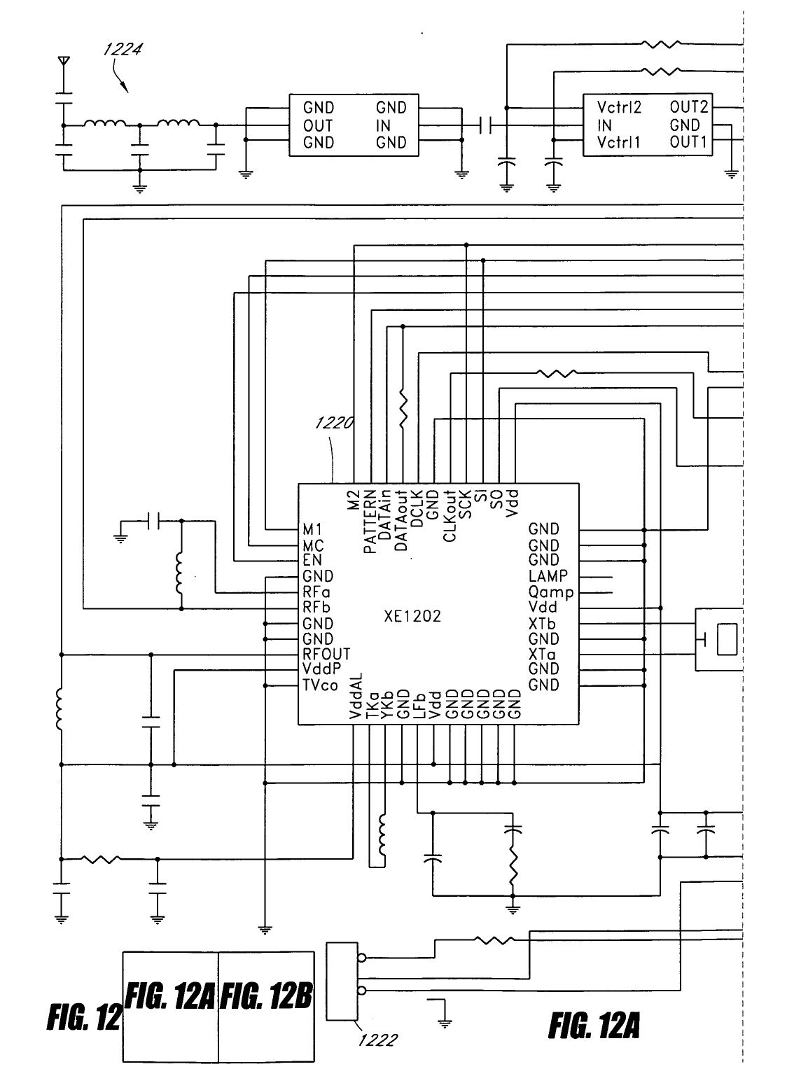

FIG. 11 illustrates a block diagram of an exemplary embodiment of inner components of a transceiver system 1100. For exemplary purposes, the transceiver system 1100 will be described hereinafter with reference to the components of the automated telescope system 100 illustrated in FIG. 1.

As shown, the transceiver system 1100 comprises an interface port module 1118 that communicates with a transceiver module 1120, a connector 1122 and antenna circuitry 1124. In certain embodiments, the transceiver system 1100 receives wireless data through the antenna circuitry 1124 from, for example, the controller 120. This data, which may contain command signals relating to the positioning and/or alignment of the telescope 102, is then processed by the interface port module 1118 and/or the transceiver module 1120 to be sent through the connector 1122 to the appropriate motor assemblies 108, 110.

In certain embodiments, the transceiver system 1100 translates commands received from an associated controller into control signals, such as, for example, motor motion commands. For example, in response to various direction, speed, focus and mode commands input into and sent from the controller 120, the transceiver system 1100 may output appropriate control signals for the azimuth motor assembly 108, the altitude motor assembly 110, and/or a control signal coupled to an auxiliary bus. These control signals are subsequently used by the appropriate motor assembl(ies) to adjust the telescope 102 a desired amount about one or more axes.

In certain embodiments, command and/or status information are communicated between the motor assemblies 108, 110 and the transceiver system 1100 through the connector 1120. For example, the connector 1120 may comprise a 2-wire serial interface that handles bi-directional communication in accordance with a packet communication protocol. In such embodiments, the transceiver system 1100 may be capable of determining that sent commands and/or control signals have been appropriately executed by evaluating return status information from the appropriate motor assembly. In other embodiments, the transceiver system 1100 may forward status information to the controller 120 or another processing system for determination as to whether the appropriate telescope adjustments have been made. In certain embodiments, appropriate telescope motion, in response to a motor control signal, is ensured by evaluating feedback signals developed by an optical encoder system mechanically coupled to the motor, electronically evaluated by the motor assembly's micro controller unit, and provided to the transceiver system 1100 and/or the controller 120 as tracking computational input.

With regard to communication between the transceiver system 1100 and a semi-intelligent motor assembly, commands are preferably provided in serial fashion to the motor assembly in accordance with a packet communication protocol. In such embodiments, each command packet may comprise one or more bytes of information with each information byte being sequentially clocked into control circuitry of the motor assembly, bit-by-bit, by a serial clock signal.

In certain embodiments wherein each motor control assembly 108, 100 has a dedicated connection (e.g., a 2-wire serial interface connection) with the connector 1122 of the transceiver system 1100, the communication therebetween need not be preceded with header information. In embodiments, however, wherein the transceiver system 1100 is further capable of communicating with an auxiliary serial interface capable of hosting a multiplicity of auxiliary apparatus, information being connected between the transceiver system 1100 and a particular auxiliary apparatus may need to be preceded by an address header in order to identify the information's intended recipient.

In certain embodiments, motor motion commands sent by the transceiver system 1100 to the motor assembly comprise three bytes of information. For example, the command may include a step rate that defines the number of steps or “ticks” to take place during approximately every six milliseconds during motor operation. For instance, the format may be a two's compliment number with the first number representing the whole steps or “ticks” and the next two bytes representing the fractional portion thereof. Each step command may also include a sign (±) which determines the direction of motor motion.

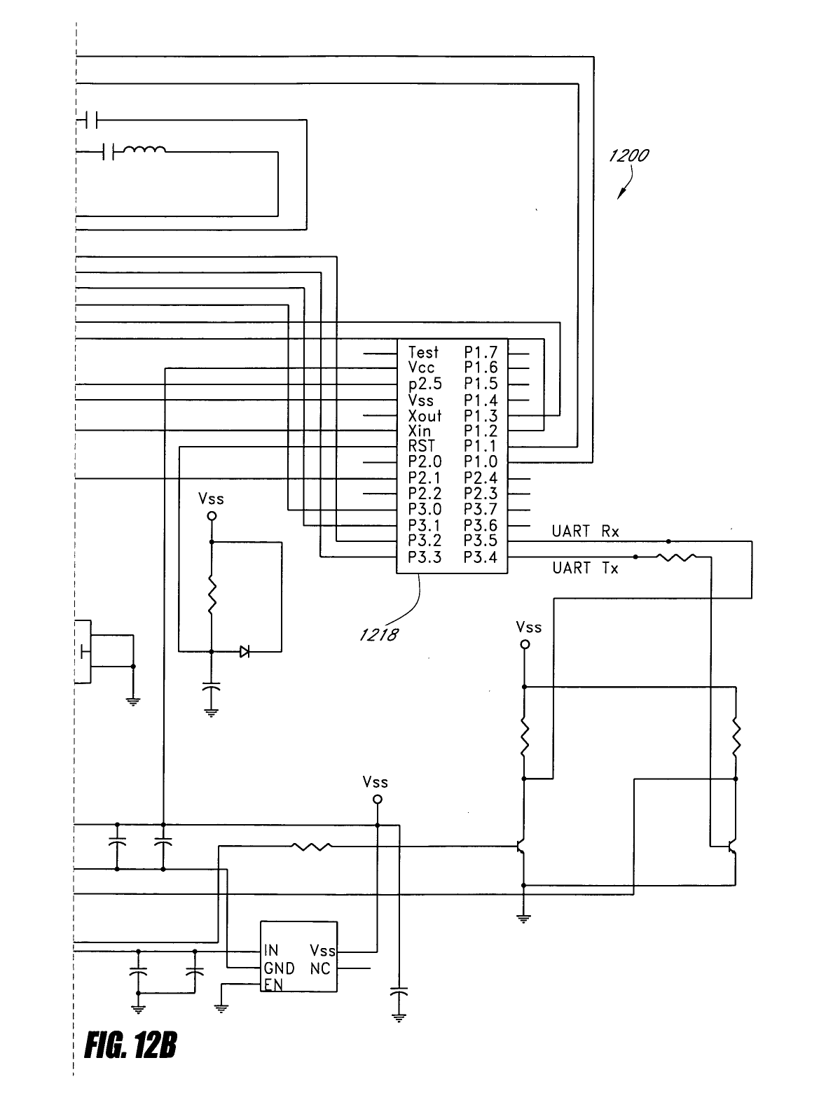

FIG. 12 illustrates a detailed schematic of an exemplary embodiment of inner components of the transceiver system 1200. As shown, the transceiver system 1220 comprises an interface port module 1218 that communicates with a transceiver module 1220, a connector 1222 and antenna circuitry 1224.

In certain embodiments, the interface port module 1218 is a UART device capable of handling asynchronous serial communication, such as received from the antenna circuitry 1224 or from the connector 1222.

The transceiver module 1220 preferably comprises a low power, integrated UHF transceiver. For example, as shown, the transceiver module 1220 comprises an XE1202 direct conversion, half-duplex data transceiver manufactured by Xemics.

As shown, the connector 1222 comprises a serial in-serial out device that is capable of transmitting and receiving information relating to the telescope system 100. In certain embodiments, the connector 1222 comprises an RJ11 connector, such as, for example, a 4-pin or an 8-pin RJ11 connector

The antenna circuitry 1224 is advantageously configured to transmit and/or receive information from a remote device, such as the controller 120. In certain embodiments, the antenna circuitry 1224 is advantageously formed by a trace on a printed circuit board and is capable of RF transmission.

Although the foregoing has been described in terms of certain preferred embodiments, other embodiments will be apparent to those of ordinary skill in the art from the disclosure herein. By way of example and not limitation, the wireless controller 120 and some or all of its functionality may advantageously be implemented using a laptop and standard wireless communication protocol, a cell phone, a PDA, or the like. Moreover, the controller 120 may advantageously comprises a “dumb terminal,” with some or all of the processing being performed on processing circuitry on the telescope 100. Alternatively, the controller 120 may perform some or all processing tasks including monitoring the feedback controls from the electric motors positioning the telescope tube 102.

In addition to the foregoing, while certain embodiments have been described, these embodiments have been presented by way of example only, and do not limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

What is claimed is:

1. A telescope system having an electronic positioning subsystem, the telescope system comprising:
a wireless control device capable of receiving user input and capable of transmitting at least one command signal based at least on the user input;
a first motor assembly capable of adjusting a position of a telescope;
a transceiver capable of receiving the at least one command signal from the wireless control device and outputting at least one control signal to the first motor assembly to adjust the position of the telescope.

2. The telescope system of claim 1, wherein the wireless control device and the transceiver are capable of radio frequency (RF) communication.

3. The telescope system of claim 1, further comprising a second motor assembly, wherein the first motor assembly is configured to rotate the telescope about one of two orthogonal axes, and the second motor assembly is configured to rotate the telescope about the other of the two orthogonal axes.

4. The telescope system of claim 1, further comprising a database capable of storing data relating to the locations of a plurality of astronomical objects.

5. The telescope system of claim 1, wherein the wireless control device is further configured to couple to a computing device capable of supplying the user input.

6. An electronic system capable of generating signals to adjust an optical instrument usable to view distant objects, the electronic system comprising:
a controller capable of transmitting to a transceiver one or more command signals usable to adjust a field of view of an optical instrument, the controller further comprising:
at least one input capable supplying an adjustment parameter selection of a user representing an adjustment to be made to a telescope,
a processor for receiving the adjustment parameter selection from the at least one input, the processor further capable of generating the one or more command signals based at least in part on said adjustment parameter selection, and
an antenna capable of wirelessly transmitting the one or more command signals.

7. The electronic system of claim 6, further comprising a transceiver capable of receiving the one or more command signals usable to adjust the field of view of the optical instrument usable to view distant objects.

8. The electronic system of claim 6, wherein the antenna is capable of transmitting the one or more command signals via radio frequency (RF) communication substantially unique to the controller and the corresponding transceiver.

9. The electronic system of claim 8, wherein the controller is further configured to transmit an identification code to the transceiver prior to transmitting the one or more command signals.

10. The electronic system of claim 9, wherein the identification code is a sixteen bit code.

11. The electronic system of claim 6, wherein the controller further comprises an electronic display.

12. The electronic system of claim 6, wherein the controller is a handheld device.

13. The electronic system of claim 6, wherein the controller comprises a laptop.

14. The electronic system of claim 13, wherein the antenna comprises a Bluetooth antenna.

15. The electronic system of claim 6, wherein the controller further comprises an RS-232 connector.

16. A method of communicating commands for electronically adjusting a position of a telescope, the method comprising:
receiving, with an electronic controller, user input indicative of at least one adjustment of a position of a telescope; and
wirelessly transmitting a command signal based at least in part on said user input, wherein the command signal is usable to electronically adjust a field of view of the telescope.

17. The method of claim 16, additionally comprising receiving said command signal and outputting one or more motor control signals based at least in part on said command signal.

18. The method of claim 16, additionally comprising performing a handshake routine prior to transmitting the command signal.

19. The method of claim 16, wherein transmitting the command signal comprises transmitting the command signal via radio frequency (RF).

20. The method of claim 16, wherein the input comprises an identification of a celestial object.

21. The method of claim 20, wherein the input comprises a location of the celestial object.

22. An electronic system for adjusting a position of a telescope, the electronic system comprising:
means for receiving user input indicative of a desired adjustment of a position of a telescope;
means for wirelessly transmitting a command signal based at least in part on said user input; and
means for generating at least one control signal for adjusting the position of the telescope, wherein the at least one control signal is based on said command signal.
